(19) United States
(12) Patent Application Publication
(10) Pub. No.: US 2009/0278793 A1
(43) Pub. Date: Nov. 12, 2009

(54) INFORMATION PROCESSING DEVICE, INFORMATION PROCESSING METHOD, AND MEDIUM RECORDING INFORMATION PROCESSING PROGRAM

(75) Inventors: Takashi Hirano, Kawasaki (JP); Ryuichi Iwamasa, Tokto (JP); Takayuki Yamaji, Kawasaki (JP); Noriko Yanai, Kawasaki (JP); Kazutoshi Sakaguchi, Kawasaki (JP); Kotaro Teranishi, Kawasaki (JP); Takefumi Horie, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/117,989

(22) Filed: May 9, 2008

(51) Int. Cl. G09G 5/00

(52) U.S. Cl. 345/156

(57) ABSTRACT

To provide an information processing device, an information processing method, and a medium recording an information processing program that can be operated easily.

A solid body that can be held by a user, a measurement section that is provided in the solid body and measures a state of the solid body with respect to three-dimensional space to obtain state information, a recognition section that recognizes a section facing a predetermined direction among a plurality of sections of the solid body based on the state information measured by the measurement section to set the recognized section as a selected section, and an execution section that selects and executes a function corresponding to the selected section among functions associated with a plurality of the sections in advance based on the selected section recognized by the recognition section are included.

### BACKGROUND OF THE INVENTION

1. Field of the Invention

The present invention relates to an information processing device, an information processing method, and a medium recording an information processing program that execute a function set in advance on the basis of operation.

2. Description of the Related Art

In recent years, a keyboard and a mouse are used as input devices for operating a variety of terminals such as a computer, a personal digital assistants (PDA), and an automatic teller machine (ATM) terminal, and audio-visual (AV) equipment. In addition to the above, input methods such as voice input, a touch panel, and gesture (expression) input are studied and developed actively.

In order to start an application in a personal computer and the like, techniques such as inputting a name of the application by using a keyboard and clicking an icon indicating the application by using a mouse are generally used.

There have been disclosed a user interface device having an angular speed sensor for detecting an orientation change of a handle in a horizontal plane, and a pointing device for instructing scrolling of a screen by analog input (for example, Jpn. Pat. Appln. Laid-Open Publication No. 2001-38052 and Jpn. Pat. No. 3247630).

In the past, the user has been required to determine an application to be used and take action, such as typing a keyboard and clicking a mouse, in order to start the application. For the above reason, there has been a problem that the user needs to remember a correct spelling of the application to be started and a shape of an icon, and this is a burden for a child and an elderly person.

In recent years, the amount of information to be handled has greatly increased. Accordingly, there has been an increasing need for an operation device with which the user can intuitively handle information.

In addition, home appliances, personal computers, have had many functions. In order to operate such many functions, the user needs to repeat menu selection in more and more occasions. The above devices have been required to be more user friendly for a wide range of users.

### SUMMARY OF THE INVENTION

An embodiment of the present invention provides an information processing device, an information processing method, and a medium recording an information processing program that can be operated easily.

In order to achieve the above object, an aspect of the present invention includes a solid body, a measurement section that is provided in the solid body and measures a state of the solid body with respect to three-dimensional space to obtain state information; a recognition section that recognizes a section facing a predetermined direction among a plurality of sections of the solid body based on the state information measured by the measurement section to set the recognized section as a selected section; and an execution section that selects and executes a function corresponding to the selected section among functions associated with a plurality of the sections in advance based on the selected section recognized by the recognition section.

In addition, an aspect of the present invention carries out recognizing and setting as a selected section a section facing a predetermined direction among a plurality of sections of a solid body, based on state information measured by a measurement section that is provided in the solid body and measures a state of the solid body with respect to three-dimensional space to obtain the state information; and selecting and executing a function corresponding to the selected section among functions associated with a plurality of the sections in advance based on the recognized selected section.

In addition, an aspect of the present invention is a medium recording an information processing program in a manner that the information processing program can be read out by a computer, that carries out recognizing and setting as a selected section of a section facing a predetermined direction among a plurality of sections of a solid body, based on state information measured by a measurement section that is provided in the solid body and measures a state of the solid body with respect to three-dimensional space to obtain the state information; and selecting and executing a function corresponding to the selected section among functions associated with a plurality of the sections in advance based on the recognized selected section.

### BRIEF DESCRIPTION OF THE DRAWINGS

FIG. 1 is a block diagram showing an example of a configuration of an information browsing system according to the present embodiment;

FIG. 2 is a perspective view showing an example of a shape of an operation device 11 according to the present embodiment;

FIG. 3 is a development view showing an example of information of a surface of the operation device 11 according to the present embodiment;

FIG. 4 is a block diagram showing an example of a configuration of the operation device 11 according to the present embodiment;

FIG. 5 is a block diagram showing an example of a hardware configuration of a host PC 12 according to the present embodiment;

FIG. 6 is a block diagram showing an example of a software configuration of the host PC 12 according to the present embodiment;

FIG. 7 is a flowchart showing an example of an operation of an operation recognition device 52 according to the present embodiment;

FIG. 8 is a flowchart showing an example of an operation of a stationary determination processing according to the present embodiment;

FIG. 9 is a flowchart showing an example of an operation of a top surface determination processing according to the present embodiment;

FIG. 10 is a flowchart showing an example of an operation of a rotation determination processing according to the present embodiment;

FIG. 11 is a flowchart showing an example of an operation of a function execution section 53 according to the present embodiment;

FIG. 12 is a table showing an example of a configuration of a content DB 54 according to the present embodiment;

FIG. 13 is a conceptual view showing an example of a configuration of a page of a function G1 according to the present embodiment;

FIG. 14 is a view showing an example of a page of the function G1 according to the present embodiment;

FIG. 15 is a view showing an example of a page of a function G2 according to the present embodiment;

FIG. 16 is a view showing an example of a page of a function G3 according to the present embodiment;

FIG. 17 is a view showing an example of a page of a function G4 according to the present embodiment;

FIG. 18 is a view showing an example of a page of a function G5 according to the present embodiment;

FIG. 19 is a view showing an example of a page of a function G6 according to the present embodiment;

FIG. 20 is a conceptual view showing a first application example of an information processing device of the present invention;

FIG. 21 is a conceptual view showing a second application example of the information processing device of the present invention;

FIG. 22 is a conceptual view showing a third application example of the information processing device of the present invention;

FIG. 23 is a conceptual view showing a fourth application example of the information processing device of the present invention;

FIG. 24 is a conceptual view showing a fifth application example of the information processing device of the present invention;

FIG. 25 is a conceptual view showing a sixth application example of the information processing device of the present invention;

FIG. 26 is a conceptual view showing a seventh application example of the information processing device of the present invention;

FIG. 27 is a conceptual view showing an eighth application example of the information processing device of the present invention;

FIG. 28 is a conceptual view showing a ninth application example of the information processing device of the present invention;

FIG. 29 is a conceptual view showing a 10th application example of the information processing device of the present invention;

FIG. 30 is a conceptual view showing an 11th application example of the information processing device of the present invention;

FIG. 31 is a conceptual view showing a 12th application example of the information processing device of the present invention;

FIG. 32 is a conceptual view showing a 13th application example of the information processing device of the present invention;

FIG. 33 is a conceptual view showing a 14th application example of the information processing device of the present invention;

FIG. 34 is a conceptual view showing a 15th application example of the information processing device of the present invention; and

FIG. 35 is a conceptual view showing a 16th application example of the information processing device of the present invention.

### DETAILED DESCRIPTION OF THE PREFERRED EMBODIMENTS

Hereinafter, an embodiment of the present invention will be described with reference to the accompanying drawings.

In the present embodiment, description will be made with respect to an information browsing system to which an information processing device according to the present invention is applied. The information browsing system is a system used for browsing information the user desires.

A configuration of the information browsing system according to the present embodiment will be described below.

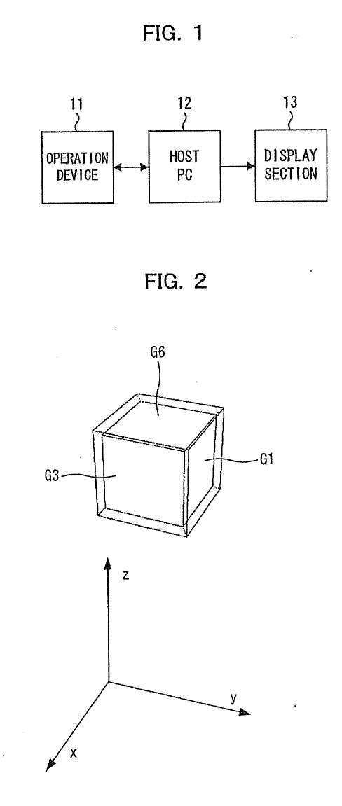

FIG. 1 is a block diagram showing an example of a configuration of the information browsing system according to the present embodiment. The information browsing system includes an operation device 11, a host personal computer (PC) 12, and a display section 13. In the present embodiment, the operation device 11 and the host PC 12 are wireless-connected, and the host PC12 and the display section 13 are wire-connected.

The display section 13 is, for example, a display. The display section 13 displays screen information output from the host PC 12.

A configuration of the operation device 11 will be described hereinafter.

FIG. 2 is a perspective view showing an example of a shape of the operation device 11 according to the present embodiment. In addition, FIG. 2 shows an x-axis, a y-axis, and a z-axis set in the operation device 11.

The operation device 11 can be held by the user. In addition, a shape of the operation device 11 according to the present embodiment is a cube. In addition, a surface of the operation device 11 has square surfaces G1, G2, G3, G4, G5, and G6. Although the shape of the operation device 11 is a cube in the present embodiment, other polyhedrons or a solid body such as a sphere may be used. The operation device 11 can be held by the user.

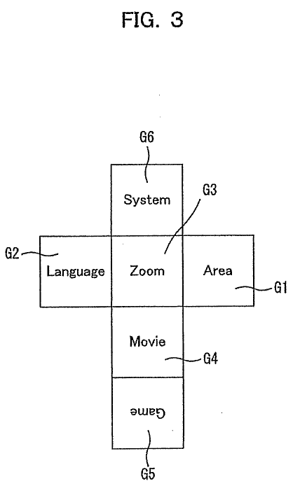

FIG. 3 is a development view showing an example of information of the surface of the operation device 11 according to the present embodiment. The surfaces G1, G2, G3, G4, G5, and G6 have pieces of information (letters and figures) different from each other. In addition, information on each of the surfaces is associated with a function different from one another. The surface G1 (surface ID=G1) has the letters “Area” drawn thereon. The surface G2 (surface ID=G2) has the letters “Language” drawn thereon. The surface G3 (surface ID=G3) has the letters “Zoom” drawn thereon. The surface G4 (surface ID=G4) has the letters “Movie” drawn thereon. The surface G5 (surface ID=G5) has the letters “Game” drawn thereon. The surface G6 (surface ID=G6) has the letters “System” drawn thereon.

A function G1 “Area” of when the surface G1 is on a top surface indicates a function of selecting an area. A function G2 “Language” of when the surface G2 is on the top surface indicates a function of selecting a language. A function G3 “Zoom” of when the surface G3 is on the top surface indicates a function of enlarging display. A function G4 “Movie” of when the surface G4 is on the top surface indicates a function of reproducing a movie. A function G5 “Game” of when the surface G5 is on the top surface indicates a function of executing a game. A function G6 “System” of when the surface G6 is on the top surface indicates a function of introducing a system.

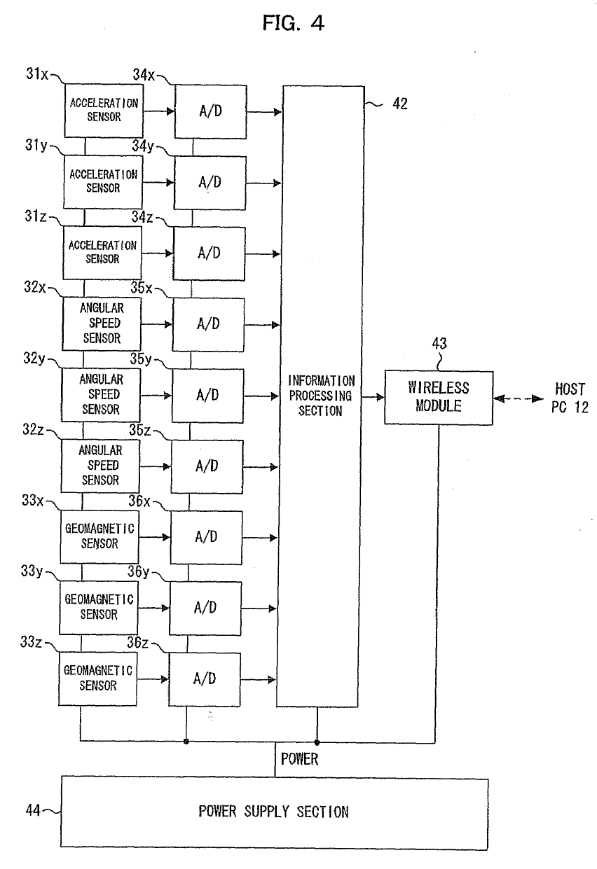

FIG. 4 is a block diagram showing an example of a configuration of the operation device 11 according to the present embodiment. The operation device 11 includes acceleration sensors 31x, 31y, and 31z, angular speed sensors 32x, 32y, and 32z, geomagnetic sensors 33x, 33y, and 33z, A/D converters (A/D) 34x, 34y, 34z, 35x, 35y, 35z, 36x, 36y, and 36z, an information processing section 42, a wireless module 43, and a power supply unit 44.

The acceleration sensors 31x, 31y, and 31z detect acceleration in an x-direction, a y-direction and a z-direction, respectively. Then, each of the acceleration sensors 31x, 31y, and 31z outputs an acceleration signal of an analog value. The angular speed sensors 32x, 32y, and 32z detect angular speeds of rotation around the x-axis, the y-axis, and the z-axis, respectively. Then, each of the angular speed sensors 32x, 32y, and 32z outputs an angular speed signal of an analog value. The geomagnetic sensors 33x, 33y, and 33z detect geomagnetisms in the x-direction, the y-direction and the z-direction, respectively. Then, each of the geomagnetic sensors 33x, 33y, and 33z output a geomagnetic signal of an analog value.

The A/D converters 34x, 34y, and 34z convert the acceleration signals output from the acceleration sensors 31x, 31y, and 31z, respectively, to acceleration information of a digital value. The A/D converters 35x, 35y, and 35z convert the angular speed signals output from the angular speed sensors 32x, 32y, and 32z, respectively, to angular speed information of a digital value. The A/D converters 36x, 36y, and 36z convert the geomagnetic signals output from the geomagnetic sensors 33x, 33y, and 33z, respectively, to geomagnetic information of a digital value.

The information processing section 42 generates operation device information (state information) based on the A/D converters 34x, 34y, 34z, 35x, 35y, 35z, 36x, 36y, and 36z. The operation device information includes three-axis acceleration information, three-axis angular speed information, and three-axis geomagnetic information. The three-axis acceleration information puts together the acceleration information output from the A/D converters 34x, 34y, and 34z. The three-axis angular speed information puts together the angular speed information output from the A/D converters 35x, 35y, and 35z. The three-axis geomagnetic information puts together geomagnetic information output from the A/D converts 36x, 36y, and 36z.

The wireless module 43 wirelessly transmits the operation device information to the host PC 12 at measuring intervals which are predetermined time intervals. The measuring interval is, for example, 1/64 sec.

The power supply unit 44 includes a battery and a switch. When the switch is turned on, the power supply unit 44 supplies power to each section of the operation device 11 from the battery.

A configuration of the host PC 12 will be described hereinafter.

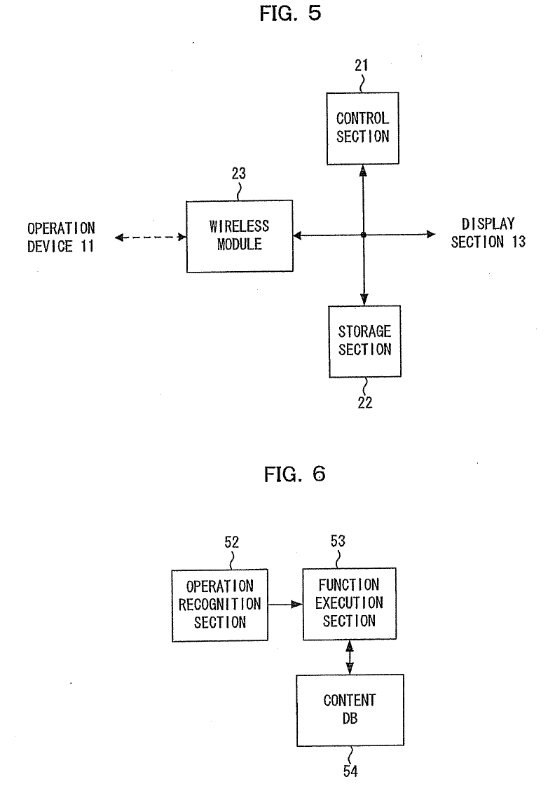

FIG. 5 is a block diagram showing an example of a hardware configuration of the host PC 12 according to the present embodiment. The host PC 12 includes a control section 21, a storage section 22, and a wireless module 23.

The wireless module 23 receives the operation device information wirelessly transmitted from the wireless module 43 of the operation device 11. The wireless module 23 and the wireless module 43 carry out wireless communication using a predetermined wireless communication system (for example, Serial Port Profile of Bluetooth (trademark)).

The storage section 22 is, for example, a memory and a magnetic disc. The control section 21 is, for example, a central processing unit (CPU). The control section 21 executes the following software stored in the storage section 22.

FIG. 6 is a block diagram showing an example of a software configuration of the host PC 12 according to the present embodiment. The host PC 12 includes an operation recognition section 52 (recognition section), a function execution section 53 (execution section), and a content database (DB) 54.

The content DB 54 retains a content (information set in advance) which serves as a basis of screen information.

The operation recognition section 52 recognizes operation of the operation device 11 by the user based on the operation device information received from the wireless module 23. Then, the operation recognition section 52 generates an event. In addition, the operation recognition section 52 manages a state flag, stationary time, a horizontal rotational angle, attitude information, and the like. The state flag indicates whether the operation device 11 is in a stationary state or not. The stationary time indicates a period of time in which the stationary state continues. The horizontal rotational angle indicates a rotational angle around a vertical angle. The attitude information indicates an attitude of the operation device 11.

The function execution section 53 executes a function with respect to a content retained by the content DB 54 based on the event generated by the operation recognition section 52. Then, the function execution section 53 displays screen information obtained as a result of such execution on the display section 13.

Operation of the information browsing system according to the present embodiment will be described below.

Operation of the operation device 11 will be described hereinafter.

After power is supplied to the operation device 11, the information processing section 42 acquires the three-axis acceleration information, the three-axis angular speed information, and the three-axis geomagnetic information at the measuring intervals to generate the operation device information.

The wireless module 43 transmits the operation device information to the host PC at the measuring intervals.

Operation of the operation recognition section 52 will be described hereinafter.

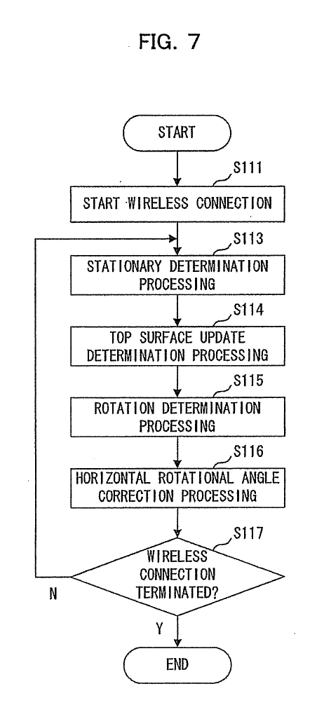

FIG. 7 is a flowchart showing an example of operation of the operation recognition device 52 according to the present embodiment. First, the operation recognition section 52 recognizes that wireless connection between the wireless module 23 and the operation device 11 is started (S111). Next, the operation recognition section 52 carries out stationary determination processing for determining whether the operation device 11 is stationary or not (S113). Next, the operation recognition section 52 carries out top surface update determination processing for determining whether a top surface (selected surface) of the operation device 11 has been updated or not (S114). Next, the operation recognition section 52 carries out rotation determination processing for determining whether the operation device 11 has rotated around the vertical axis (S115). Next, the operation recognition section 52 calculates the attitude information based on the three-axis geomagnetic information. Then, the operation recognition section 52 carries out horizontal rotational angle correction processing for correcting a horizontal rotational angle and the like based on the attitude information (S116). By the above correction, cumulative errors in a horizontal rotational angle calculated based on the three-axis angular speed information can be prevented.

Next, the operation recognition section 52 determines whether the wireless connection between the wireless module 23 and the operation device 11 has been terminated or not (S117). In the case where the wireless connection has not been terminated (S117, N), the processing moves to the processing of S113. In the case where the wireless connection has been terminated (S117, Y), this flow ends.

The stationary determination processing carried out by the operation recognition section 52 will be described hereinafter.

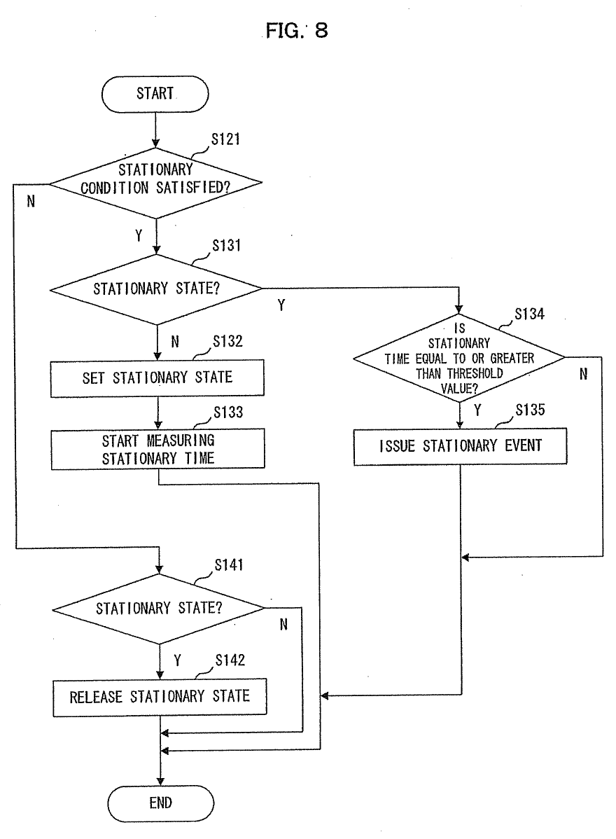

FIG. 8 is a flowchart showing an example of operation of the stationary determination processing according to the present embodiment. First, the operation recognition section 52 determines whether or not a stationary condition is satisfied or not (S121). The stationary condition is that, among three components of the three-axis acceleration information, absolute values of two components are equal to or lower than a predetermined minimum acceleration threshold value and an absolute value of one component is within a predetermined range of a gravitational acceleration.

In the case where the stationary condition is satisfied (S121, Y), the operation recognition section 52 determines whether the state flag is in a stationary state (S131).

In the case where the state flag is not in a stationary state (S131, N), the operation recognition section 52 sets the stationary state of the state flag (S132). Then, the operation recognition section 52 resets stationary time and starts measurement of stationary time (S133), and this flow ends.

In the case where the state flag is in the stationary state (S131, Y), the operation recognition section 52 determines whether stationary time is equal to or greater than a stationary time threshold value (S134). In the case where the stationary time is equal to or greater than the stationary time threshold value (S134, Y), the operation recognition section 52 issues a stationary event (S135), and this flow ends. In the case where the stationary time is lower than the stationary time threshold value (S134, N), this flow ends.

In the case where the stationary condition is not satisfied (S121, N), the operation recognition section 52 determines whether the state flag is in a stationary state (S141).

In the case where the state flag is in a stationary state (S141, Y), the operation recognition section 52 releases the stationary state of the state flag (S142), and this flow ends.

In the case where the state flag is not in the stationary state (S141, N), this flow ends.

The top surface update determination processing carried out by the operation recognition section 52 will be described hereinafter.

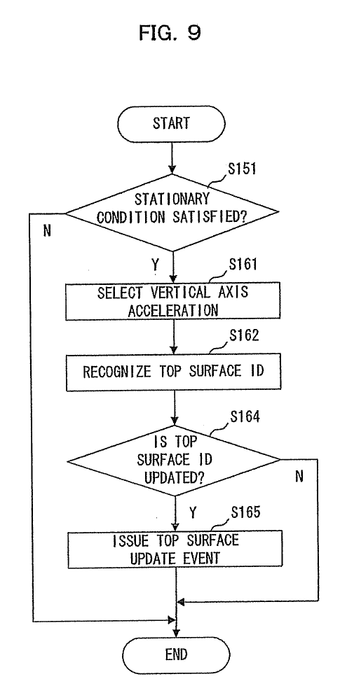

FIG. 9 is a flowchart showing an example of an operation of the top surface update determination processing according to the present embodiment. First, the operation recognition section 52 determines whether the stationary condition described above is satisfied or not (S151).

In the case where the stationary condition is not satisfied (S151, N), this flow ends.

In the case where the stationary condition is satisfied (S151, Y), the operation recognition section 52 selects one component having an absolute value within a range of a gravitational acceleration from three components of the three-axis acceleration information and sets the selected one component as a vertical axis acceleration (S161). Here, candidates for the top surface of the six surfaces of the operation device 11 are two surfaces perpendicular to the vertical axis acceleration. Next, the operation recognition section 52 recognizes a surface ID of the top surface of the two surfaces as candidates based on a sign of the vertical axis acceleration and sets the recognized surface ID as a new top surface ID (S162).

As an example, description will be made with respect to a case where a vertical axis acceleration is a z-component and a sign of the vertical axis acceleration is negative. First, the operation recognition section 52 selects a surface G3 and a surface G6 perpendicular to the z-axis as candidates for the top surface based on that a vertical axis is the z-axis. Next, the operation recognition section 52 selects the surface G6 on the opposite side of a gravity direction as the top surface based on that a sign of the vertical axis acceleration is negative.

Next, the operation recognition section 52 determines whether the top surface ID has been updated or not based on recognition of the top surface ID (S164).

In the case where the top surface ID has been updated (S164, Y), the operation recognition section 52 issues a top surface update event including a new top surface ID and resets a horizontal rotational angle (S165). Then, this flow ends.

In the case where the top surface ID has not been updated (S164, N), this flow ends.

The rotation determination processing carried out by the operation recognition section 52 will be described hereinafter.

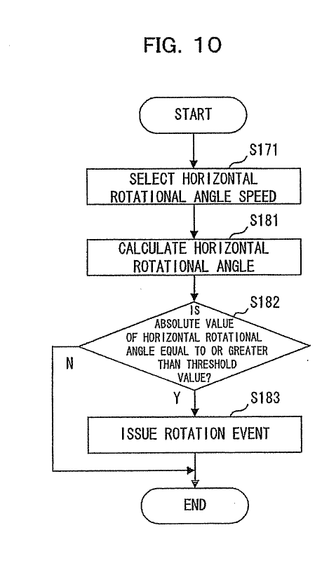

FIG. 10 is a flowchart showing an example of an operation of the rotation determination processing according to the present embodiment. First, the operation recognition section 52 selects an angular speed around a vertical angle among three components of the three-axis angular speed information based on the top surface ID and sets the selected angular speed to be a horizontal rotational angle speed (S171).

Next, the operation recognition section 52 calculates a new horizontal rotational angle based on a retained horizontal rotational angle, the measurement intervals, and the horizontal rotational angular speed and then updates the horizontal rotational angle (S181). Next, the operation recognition section 52 determines whether an absolute value of the horizontal rotational angle is equal to or greater than a predetermined threshold value of a horizontal rotational angle (S182). Here, the threshold value of a horizontal rotational angle is, for example, 45 degrees.

In the case where an absolute value of the horizontal rotational angle is equal to or greater than the threshold value of a horizontal rotational angle (S182, Y), the operation recognition section 52 issues a rotation event including a rotational direction (right rotation or left rotation, a sign of a horizontal rotational angle). Then, the operation recognition section 52 resets the horizontal rotational angle (S183), and this flow ends.

In the case where an absolute value of the horizontal rotational angle is lower than the threshold value of a horizontal rotational angle (S182, N), this flow ends.

Here, each of the events described above will be described. The top surface update event corresponds to selection of a function. The stationary event corresponds to determination of a selected item. These events correspond to a decision button, an OK button, an enter key, and the like in a conventional information browsing application respectively. And the rotation event corresponds to movement of a selected item. This corresponds to a scroll bar, up and down keys, left and right keys, and the like in the conventional information browsing application.

Operation of the function execution section 53 will be described hereinafter.

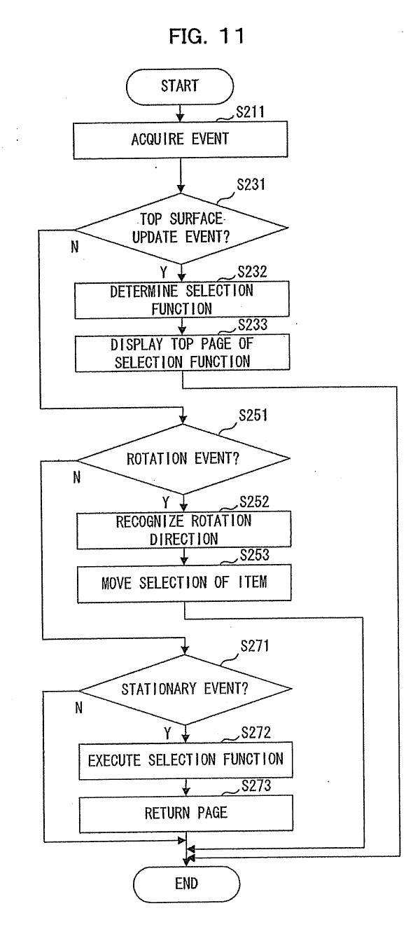

FIG. 11 is a flowchart showing an example of an operation of the function execution section 53 according to the present embodiment. Every time the operation recognition section 52 issues an event, this flow is executed.

First, the function execution section 53 acquires an event issued by the operation recognition section 52 (S211). Next, the function execution section 53 determines whether the top surface update event is issued or not (S231).

In the case where the top surface update event is issued (S231, Y), the function execution section 53 selects a function corresponding to the top surface ID from the content DB 54 to determine a selected function (S232). Then, the function execution section 53 acquires a top page of the selected function and displays the top page on the display section 13 (S233). Then, this flow ends.

In the case where the top surface update event has not been issued (S231, N), the function execution section 53 determines whether the rotation event has been issued or not (S251).

In the case where the rotation event has been issued (S251, Y), the function execution section 53 recognizes a rotation direction included in the rotation event (S252). The function execution section 53 moves the selected item in a menu on a displayed page in the rotation direction (S253). Then, this flow ends.

For example, in the case where the rotation event indicates right rotation, the function execution section 53 selects an item obtained by increasing an item number for one in the menu on the displayed page. Then, the function execution section 53 sets the item selected in this manner as a selected item. In addition, in the case where the rotation event indicates left rotation, the function execution section 53 selects an item obtained by decreasing an item number for one in the menu on the displayed page. Then, the function execution section 53 sets the item selected in this manner as a selected item.

In the case where the rotation event has not been issued (S251, N), the function execution section 53 determines whether the stationary event has been issued or not (S271).

In the case where the stationary event has been issued (S271, Y), the function execution section 53 executes a selection function with respect to the selected item, and displays a result of such execution on the display section 13 (S272). When the execution of the selection function ends, the function execution section 53 returns to the page before the execution and displays the page on the display section 13 (S273). Then, this flow ends.

In the case where the stationary event has not been issued (S271, N), this flow ends.

A configuration of the content DB 54 will be described hereinafter.

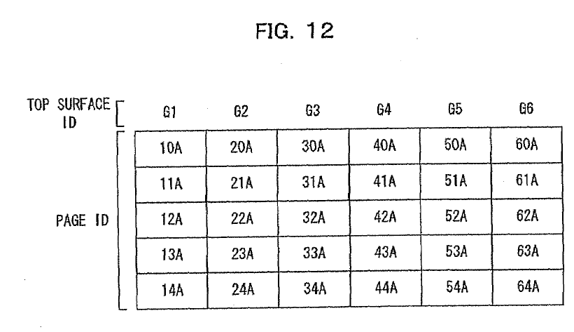

The content DB 54 retains a plurality of contents for each of the top surface IDs. FIG. 12 is a table showing an example of a configuration of the content DB 54 according to the present embodiment. FIG. 12 shows the top surface ID and a page ID which is an ID of a page corresponding to the top surface ID.

In addition, in a matrix of page IDs shown in FIG. 12, a column is selected by the top surface update event and a row is selected by the rotation event.

A content of a function G1 “Area” will be described hereinafter.

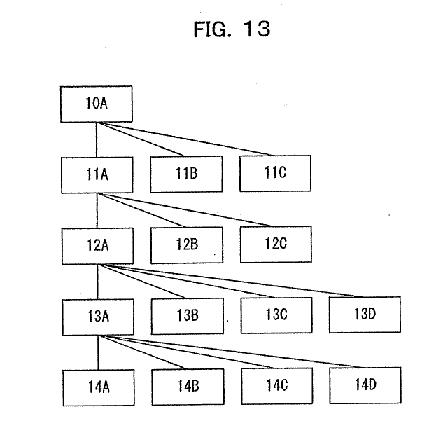

FIG. 13 is a conceptual view showing an example of a configuration of a page of the function G1 according to the present embodiment. FIG. 13 shows a structure of a page of the function G1 with a page ID. The page of the function G1 has a hierarchical structure. A top page of the function G1 is 10A. From a menu in 10A, the user can select 11A, 11B, and 11C as a lower layer of 10A. From a menu in 11A, the user can select 12A, 12B, and 12C as a lower layer of 11A.

From a menu in 12A, the user can select 13A, 13B, 13C, and 13D as a lower layer of 12A. From a menu in 13A, the user can select 14A, 14B, 14C, and 14D as a lower layer of 13A.

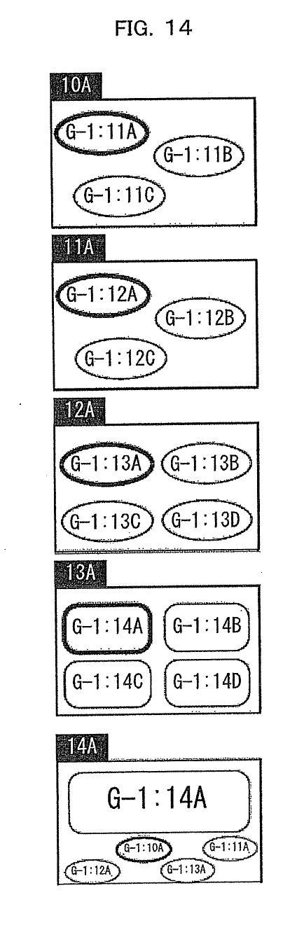

FIG. 14 is a view showing an example of a page of the function G1 according to the present embodiment. FIG. 14 shows displays of 10A, 11A, 12A, 13A, and 14A which are pages of the function G1. Each of the above pages displays a menu having items showing pages of a lower layer. Here, a selection function is for moving to a lower layer as a selected item. The function execution section 53 moves selection of an item in a menu by the rotation event. Then, the function execution section 53 displays a page of a selected item by the stationary event.

A content of a function G2 “Language” will be described hereinafter.

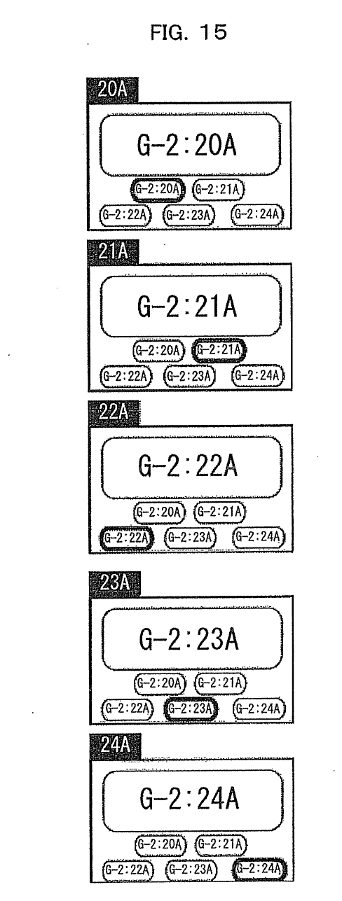

FIG. 15 is a view showing an example of a page of the function G2 according to the present embodiment. FIG. 15 shows displays of 20A, 21A, 22A, 23A, and 24A which are pages of the function G2. Each of the above pages displays a menu having items showing languages corresponding to the page.

In addition, each of the pages is associated with a language that is different from the others. Here, the selection function is for setting a language as the selected item as a language used for display. The function execution section 53 moves selection of an item in a menu by the rotation event. Then, the function execution section 53 sets a language of the selected item as a language used for display by the stationary event. When the language is set, the function execution section 53 displays subsequent pages in the set language.

A content of a function G3 “Zoom” will be described hereinafter.

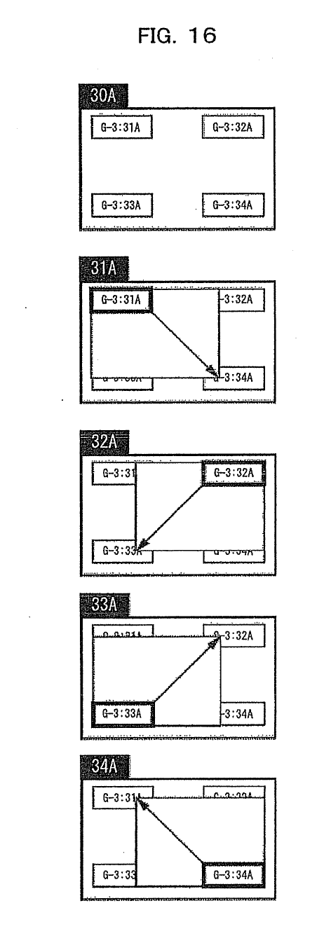

FIG. 16 is a view showing an example of a page of the function G3 according to the present embodiment. FIG. 16 shows displays of 30A, 31A, 32A, 33A, and 34A which are pages of the function G3. Each of the above pages displays a menu having items showing images corresponding to the page.

Here, the selection function is for displaying a page enlarging an image as the selected item. The function execution section 53 moves selection of an item in a menu by the rotation event. Then, the function execution section 53 enlarges an image of the selected item by the stationary event.

A content of a function G4 “Movie” will be described hereinafter.

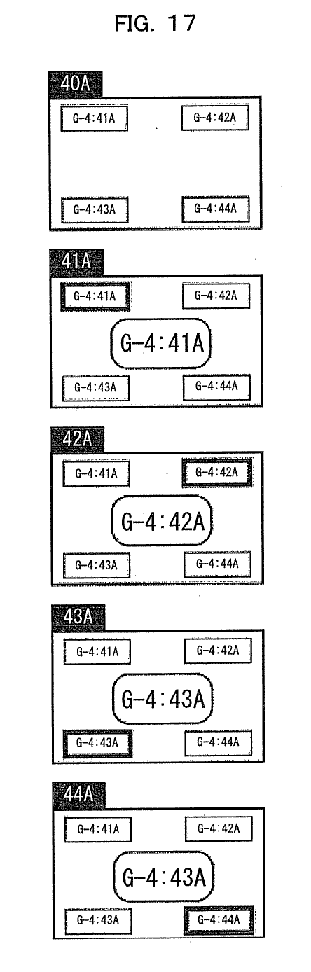

FIG. 17 is a view showing an example of a page of the function G4 according to the present embodiment. FIG. 17 shows displays of 40A, 41A, 42A, 43A, and 44A which are pages of the function G4. Each of the above pages displays a menu having items showing movies corresponding to the page. Here, the selection function is for displaying a page that reproduces a movie as the selected item.

The function execution section 53 moves selection of an item in a menu by the rotation event. Then, the function execution section 53 plays a movie of the selected item by the stationary event.

A content of a function G5 “Game” will be described hereinafter.

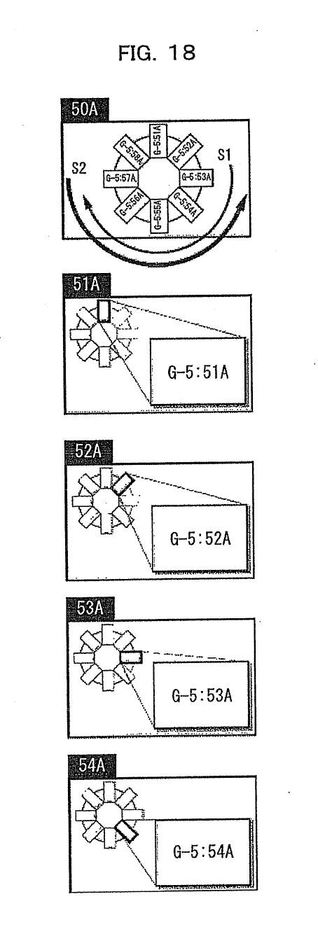

FIG. 18 is a view showing an example of a page of the function G5 according to the present embodiment. FIG. 18 shows displays of 50A, 51A, 52A, 53A, and 54A which are pages of the function G5. A top page 50A displays a circular menu having items of 50A, 51A, 52A, 53A, and 54A. The top page 50A executes a roulette for randomly selecting a page by using the rotation event as an impetus. In the top page 50A, when the rotation event of right rotation is issued as shown in S1, the function execution section 53 rotates selection of an item in a menu to the right. Then, when the rotation event of left rotation is issued as shown in S2, the function execution section 53 gradually reduces a rotational speed of the selected item in the menu, and stops the selected item. Next, the function execution section 53 displays a page for displaying an image which is an item being selected at the time when the rotation is stopped.

A content of a function G6 “System” will be described hereinafter.

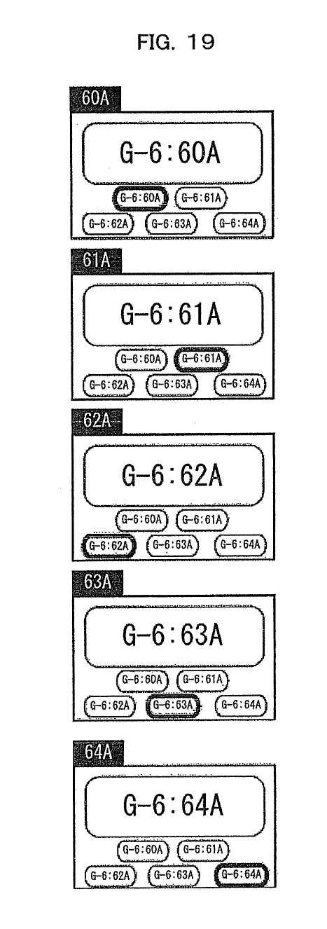

FIG. 19 is a view showing an example of a page of the function G6 according to the present embodiment. FIG. 19 shows displays of 60A, 61A, 62A, 63A, and 64A which are pages of the function G6. Each of the above pages displays a menu having items showing pages. Here, the selection function is for displaying a page which is a selected item. The function execution section 53 moves selection of an item in a menu by the rotation event. Then, the function execution section 53 displays description of the selected item by the stationary event.

According to the present embodiment, for example, in the case where a content is a travelling brochure, the user carries out designation of an area, designation of a language, zoom, and the like of the travelling brochure by simple operation. In this manner, the user can browse the travelling brochure.

Another application example of the information processing device of the present invention will be described hereinafter.

The operation device 11 described above can be used as a service provision tool in a variety of services which will be described hereinafter.

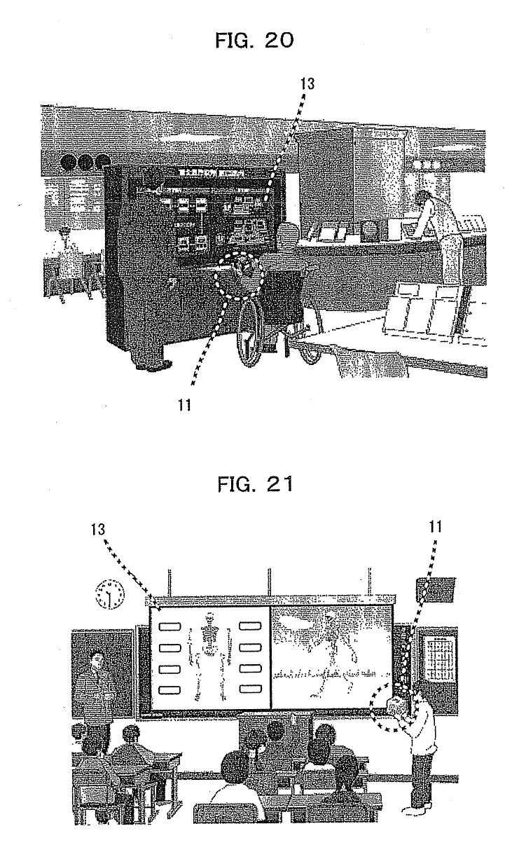

FIG. 20 is a conceptual view showing a first application example of the information processing device of the present invention. FIG. 20 shows an example in which the information processing device of the present invention is applied to guidance at a counter in a self-governing community. According to the example, the user at the counter operates the operation device 11. In this manner, target information can be displayed on the display section 13. In addition, the information processing device can manage a history of contents which are frequently used. Contents can be organized in this manner. Further, by supporting a plurality of languages, a foreigner can also use the information processing device. Moreover, with a zoom function, an elderly person can use the information processing device as well.

FIG. 21 is a conceptual view showing a second application example of the information processing device of the present invention. FIG. 21 shows an example in which the information processing device of the present invention is applied to an educational institution. According to the example, the user can carry out operation without remembering how to use a mouse and a keyboard. In addition, by wireless communication between the operation device 11 and the host PC 12, the user can operate a content from anywhere in a classroom.

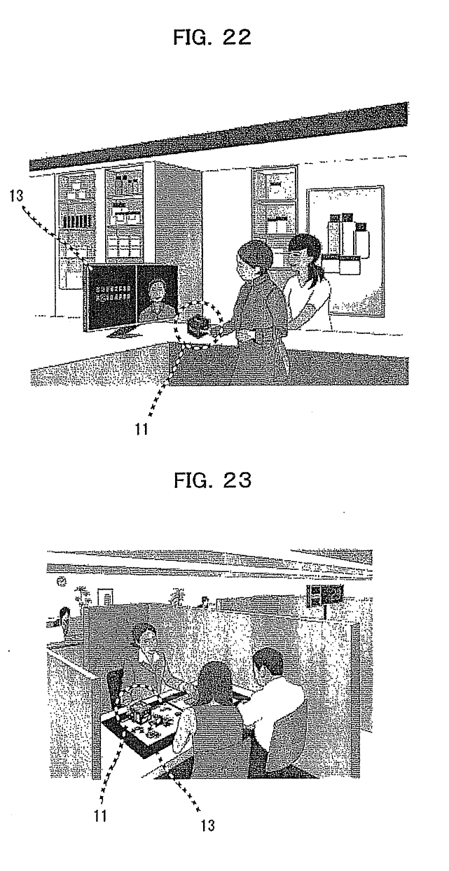

FIG. 22 is a conceptual view showing a third application example of the information processing device of the present invention. FIG. 22 shows an example in which the information processing device of the present invention is applied to a cosmetic store. According to the example, the consumer operates the operation device 11. In this manner, information of a product can be displayed on the display section 13. In addition, a salesperson can provide certain knowledge of products.

FIG. 23 is a conceptual view showing a fourth application example of the information processing device of the present invention. FIG. 23 shows an example in which the information processing device of the present invention is applied to a financial institution. According to the example, a staff member operates the operation device 11 to show the display section 13 to a consumer. In this manner, regardless of a knowledge level of the staff member, the staff member can provide description with respect to a variety of financial products and services which is easy to understand.

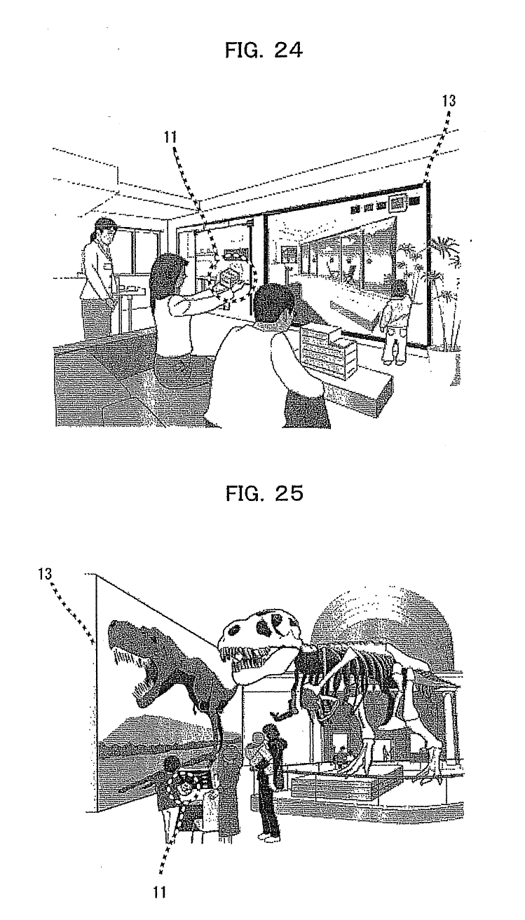

FIG. 24 is a conceptual view showing a fifth application example of the information processing device of the present invention. FIG. 24 shows an example in which the information processing device of the present invention is applied to a showroom of a house. According to the example, a consumer operates the operation device 11 to change a color of interior design, design of a kitchen, and the like. In this manner, the consumer can create a room he or she desires and the display section 13 can display the room.

FIG. 25 is a conceptual view showing a sixth application example of the information processing device of the present invention. FIG. 25 shows an example in which the information processing device of the present invention is applied to a museum. According to the example, a visitor operates the operation device 11. In this manner, a moving dinosaur can be displayed on the display section 13.

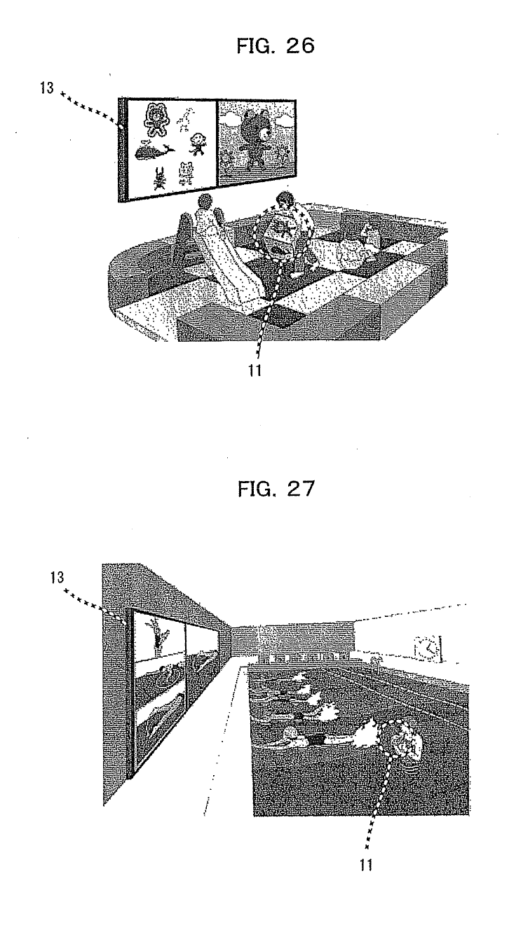

FIG. 26 is a conceptual view showing a seventh application example of the information processing device of the present invention. FIG. 26 shows an example in which the information processing device of the present invention is applied to a kids' space. According to the example, a child as a user operates the operation device 11 and views the display section 13. In this manner, even a child can operate a content easily.

FIG. 27 is a conceptual view showing an eighth application example of the information processing device of the present invention. FIG. 27 shows an example in which the information processing device of the present invention is applied to a swimming club. According to the example, an instructor operates the operation device 11 and shows the display section 13 to students. In this manner, the instructor can operate a content easily even when the instructor is in a swimming pool.

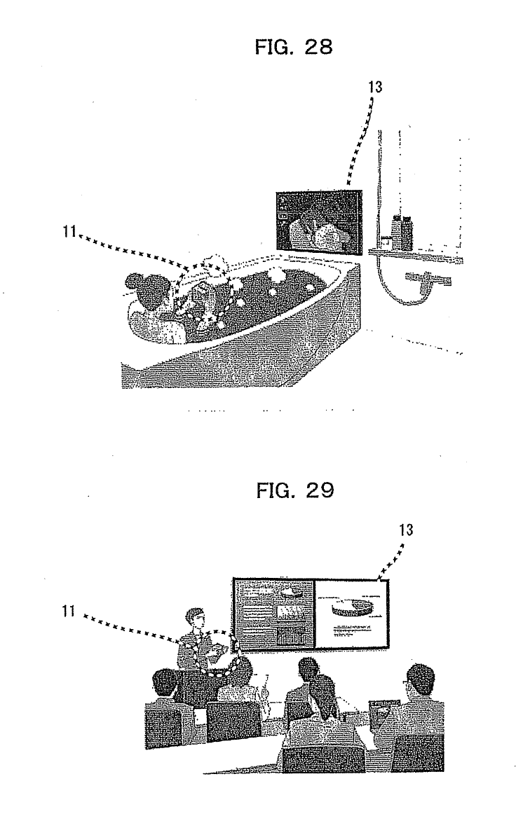

FIG. 28 is a conceptual view showing a ninth application example of the information processing device of the present invention. FIG. 28 shows an example in which the information processing device of the present invention is applied to a bathroom. According to the example, the instructor operates the operation device 11 and views the display section 13. In this manner, the user can operate a content easily even when the user is in a bathroom.

FIG. 29 is a conceptual view showing a 10th application example of the information processing device of the present invention. FIG. 29 shows an example in which the information processing device of the present invention is applied to presentation. According to the example, a presenter operates the operation device 11 and shows the display section 13. In this manner, the presenter can operate a content easily while providing explanation.

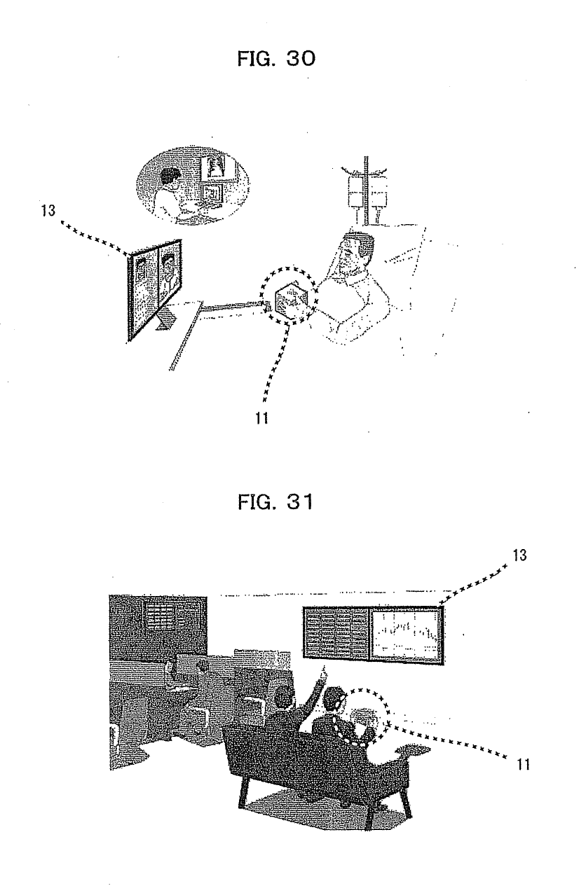

FIG. 30 is a conceptual view showing an 11th application example of the information processing device of the present invention. FIG. 30 shows an example in which the information processing device of the present invention is applied to a is medical institution. According to the example, a patient operates the operation device 11 and views the display section 13. In this manner, the patient can operate a content easily while staying in bed.

FIG. 31 is a conceptual view showing a 12th application example of the information processing device of the present invention. FIG. 31 shows an example in which the information processing device of the present invention is applied to an office of a securities company. According to the example, a customer operates the operation device 11 and views the display section 13. In this manner, the customer can operate a content easily without receiving explanation.

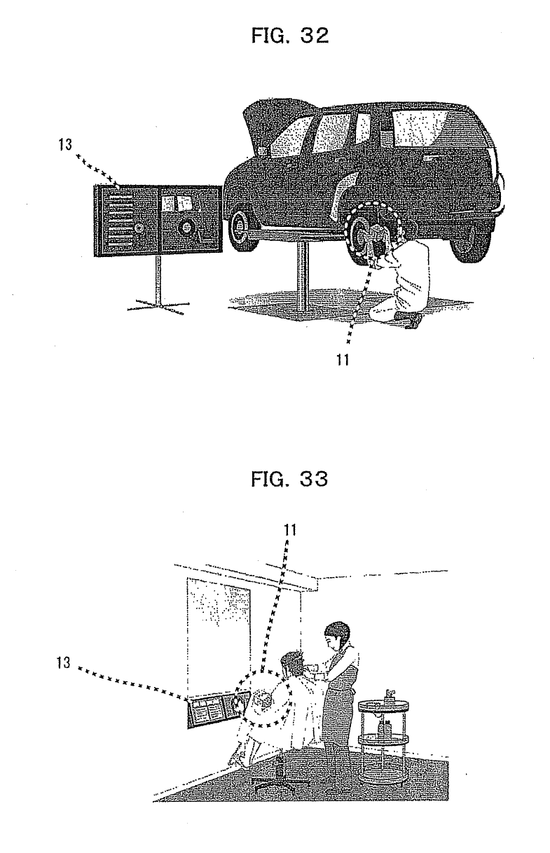

FIG. 32 is a conceptual view showing a 13th application example of the information processing device of the present invention. FIG. 32 shows an example in which the information processing device of the present invention is applied to a car maintenance facility. According to the example, a maintenance engineer operates the operation device 11 and views the display section 13. In this manner, the maintenance engineer can operate a content easily even while carrying out maintenance.

FIG. 33 is a conceptual view showing a 14th application example of the information processing device of the present invention. FIG. 33 shows an example in which the information processing device of the present invention is applied to a beauty salon. According to the example, a consumer operates the operation device 11 and views the display section 13. In this manner, the consumer can operate a content easily even while getting a haircut.

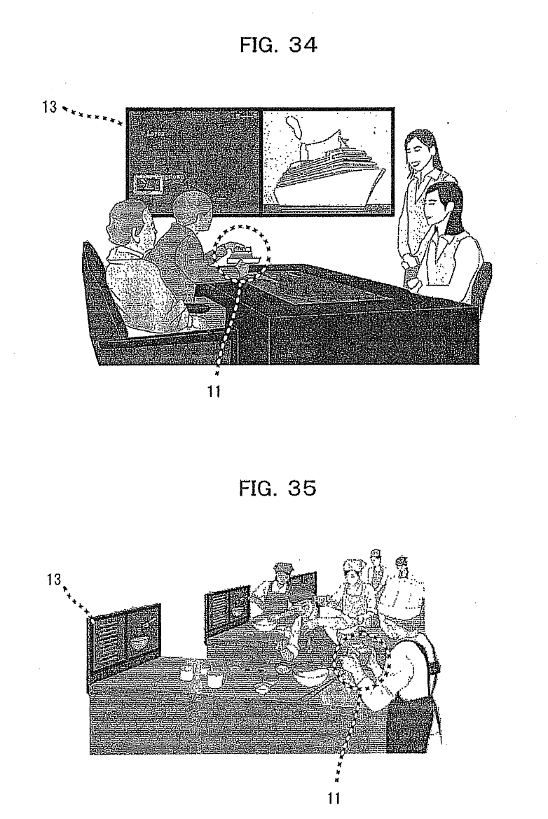

FIG. 34 is a conceptual view showing a 15th application example of the information processing device of the present invention. FIG. 34 shows an example in which the information processing device of the present invention is applied to a travel agency. According to the example, a customer operates the operation device 11 and views the display section 13. In this manner, the customer can easily grasp a content of a trip by operating a content. Here, the operation device 11 has a shape of a ship.

FIG. 35 is a conceptual view showing a 16th application example of the information processing device of the present invention. FIG. 35 shows an example in which the information processing device of the present invention is applied to a cooking seminar. According to the example, an instructor operates the operation device 11 and shows the display section 13 to students. In this manner, the instructor can operate a content easily even while providing an explanation.

According to the present embodiment, the user can browse information only by looking at and moving the operation device 11. Accordingly, the user does not need to use a large number of buttons, and pointer and cursor moving functions. In addition, the user does not need to remember correct spelling and a shape of an icon of an application that the user desires to start.

In addition, according to the present embodiment, even the user who does not have prior knowledge with respect to an information browsing system can browse information smoothly. Therefore, in presentation of a showroom and the like, the user can expand presentation into a topic that interests a customer. In addition, in response to a question from the customer, the user can start a desired function without looking for a file.

Since wireless communication is established between the operation device 11 and the host PC 12, the user can remotely operate the host PC 12 by using the operation device 11. Accordingly, the user is not restricted to stay around the display section 13 and the host PC 12 and can operate a content at an arbitrary location.

In the case where the operation device 11 has a ball shape, marks indicating corresponding functions are put on a plurality of sections on a surface of the operation device 11. In this case, a function corresponding to a mark appearing on the top is executed.

In addition, the operation device 11 may have the display section 13 on part of or whole surface thereof. In this case, the operation device 11 further has functions of the operation recognition section 52 and the function execution section 53.

In the present embodiment, simple words corresponding to operation are put on each surface of the operation device 11. However, a picture, a symbol, Braille points, and the like may be put on each surface as well. By the picture and the symbol indicating operation, anyone in the world can easily operate the operation device 11 irrespective of languages. In addition, each surface of the operation device 11 configured to have a display can change information shown on each surface depending on situations.

The host PC 12 may further include a log recording section. The log recording section records an application started by the function execution section 53, a browsed item, and a log of time. In this case, an information browsing system can carry out market research and collect product information that interests a customer without making the customer aware of such a fact.

In the present embodiment, correction based on the three-axis geomagnetic information is carried out. However, this correction may be omitted. In this case, the operation device 11 does not need the geomagnetic sensors 33x, 33y, and 33z.

In addition, the information processing device of the present invention can be applied to a service support system in a shop and service space. For example, the service support system carries out calling for stuff, selecting and ordering of a menu, browsing of information and a history, control of spatial equipment (air conditioning, lighting, acoustic system) based on operation of the polyhedron.

In addition, the information processing device of the present invention may be applied to a video distribution system. For example, the video distribution system distributes through a network a video picture selected in a menu based on operation of the polyhedron. In this manner, the user can select necessary information and a video picture in an on-demand manner.

In addition, the information processing device of the present invention may be applied to an equipment operation system, such as a switch and a remote controller. According to the equipment operation system, the user can operate the information processing device at an arbitrary location without moving.

In addition, the information browsing system according to the present embodiment uses a general wireless communication system that enables easy connection for communication between the operation device 11 and the host PC. Accordingly, by carrying around only the operation device 11, the user can use the host PC set in any location and an application therein.

In addition, the function execution section 53 and the content DB54 have a schedule management function. In this manner, each surface of the operation device 11 shows a destination of an owner. Also, the host PC 12 can acquire information on the destination and manage a schedule.

In addition, the display section 13 includes a voice (music) reproduction function, and the function execution section 53 and the content DB 54 include a management function of voice information. In this manner, the user can select voice information and adjust a sound volume by simple operation of the operation device 11. In this case, for example, the function execution section 53 controls size of a sound volume by the rotation event.

In addition, the display section 13 includes a lighting function, and the function execution section 53 and the content DB 54 include a function for controlling brightness. In this manner, the user can adjust lighting by simple operation of the operation device 11. In this case, for example, the function execution section 53 controls size of brightness of lighting by the rotation event.

In addition, an existing application may be controlled in such a manner that the operation recognition section 52 generates a command of the application in place of carrying out a variety of events, based on the operation device information.

In addition, the operation recognition section 52 generates an output that is similar to a mouse and a keyboard in place of a variety of events based on the operation device information. In this manner, the user can use the operation device 11 in place of a mouse and a keyboard.

In addition, operation by a plurality of the operation devices 11 may be recognized in such a manner that there are a plurality of the operation devices 11, each of the operation devices 11 has an operation device ID which is inherent thereto, and the operation recognition section 52 manages a plurality of the operation device IDs that are wirelessly connected.

In addition, the information processing device according to the present invention may carry out control in which the functions described above are combined.

In addition, the operation recognition section 52 may recognize that the operation device 11 is raised in an upward direction along a vertical axis to generate a rise event. Then, the function execution section 53 detecting the rise event may carry out enlarging and the like of a page currently displayed.

In addition, the operation device 11 may further include the three-axis geomagnetic sensor so as to be able to output the three-axis geomagnetic information which is information of geomagnetism in the x-direction, the y-direction, and the z-direction. In this case, the operation recognition section 52 can recognize an attitude of the operation device by using the three-axis geomagnetic information. In addition, the operation recognition section 52 can carry out correction of the attitude of the operation device obtained from the three-axis acceleration information and the three-axis angular speed information by using the three-axis geomagnetic information.

Further, a program that executes each of the steps described above in a computer configuring the information processing device can be provided as an information processing program. The program described above is stored in a recording medium which can be read out by a computer. In this manner, the program can be executed by a computer configuring the information processing device. Here, the recording medium which can be read out by a computer described above includes an internal storage device implemented internally in a computer such as a ROM and a RAM, a CD-ROM and a flexible disc, a DVD disc, a magneto-optical disc, a portable storage medium such as an IC card, and a database retaining a computer program, or other computers and a database thereof, and further an online transmission medium.

The present invention can be implemented in a variety of other forms without deviating from a gist and a principal characteristic thereof. Therefore, the embodiment described above is a mere exemplification in every aspect, and does not allow the invention to be interpreted in a limiting manner. A range of the present invention is shown by claims, and not restricted by a content of the description in any way. Further, all deformation, a variety of improvements, substitutions, modifications belonging to a uniform range of claims are all included in claims.

1. An information processing device, comprising:
a solid body;
a measurement section that is provided in the solid body and measures a state of the solid body with respect to three-dimensional space to obtain state information;
a recognition section that recognizes a section facing a predetermined direction among a plurality of sections of the solid body based on the state information measured by the measurement section to set the recognized section as a selected section; and
an execution section that selects and executes a function corresponding to the selected section among functions associated with a plurality of the sections in advance based on the selected section recognized by the recognition section.

2. The information processing device according to claim 1, wherein
the recognition section recognizes rotation around a vertical axis of the solid body based on the state information, and
the execution section executes a function associated with the rotation around the vertical axis in advance.

3. The information processing device according to claim 2, wherein
the function associated with the selected section is to display a plurality of items, and
the function associated with the rotation around the vertical angle in advance is to move selection of an item.

4. The information processing device according to claim 2, wherein
the function associated with the selected section is to output information, and
the function associated with the rotation around the vertical axis in advance is to adjust a level of the output based on the rotation.

5. The information processing device according to claim 1, wherein
the recognition section recognizes a stationary state of the solid body based on the state information, and
the execution section executes a function associated with the stationary state in advance.

6. The information processing device according to claim 5, wherein
the function associated with the selected section is to display a plurality of items, and
the function associated with the stationary state is to determine selection of an item.

7. The information processing device according to claim 1, wherein
the measurement section has a three-axis acceleration sensor, measures a three-axis acceleration and includes the three-axis acceleration in the state information.

8. The information processing device according to claim 7, wherein
the recognition section detects a gravitational acceleration based on the three-axis acceleration, and recognizes the selected section based on the gravitational acceleration.

9. The information processing device according to claim 1, wherein
the measurement section has a three-axis angular speed sensor, measures a three-axis angular speed and includes the three-axis angular speed in the state information.

10. The information processing device according to claim 9, wherein
the recognition section recognizes rotation around a vertical axis of the solid body based on the three-axis angular speed.

11. The information processing device according to claim 1, wherein
the measurement section has a three-axis geomagnetic sensor, measures a three-axis geomagnetism and includes the three-axis geomagnetism in the state information.

12. The information processing device according to claim 11, wherein
the recognition section corrects information relating to an attitude of the solid body based on the three-axis geomagnetism.

13. The information processing device according to claim 1, wherein a function corresponding to the selected section is to display information set in advance.

14. The information processing device according to claim 13, further comprising a display section that displays the information set in advance.

15. The information processing device according to claim 1, wherein
the predetermined direction is an upward direction.

16. The information processing device according to claim 1, wherein
the section is marked with information indicating a function corresponding to the section.

17. The information processing device according to claim 1, wherein
the measurement section transmits the state information through wireless communication; and
the recognition section receives the state information through wireless communication.

18. The information processing device according to claim 1, wherein
the solid body is a polyhedron, and the sections are faces of the polyhedron.

19. An information processing method, comprising the steps of:
recognizing and setting as a selected section a section facing a predetermined direction among a plurality of sections of a solid body, based on state information measured by a measurement section that is provided in the solid body and measures a state of the solid body with respect to three-dimensional space to obtain the state information; and
selecting and executing a function corresponding to the selected section among functions associated with a plurality of the sections in advance based on the recognized selected section.

20. A medium recording an information processing program in a manner that the information processing program can be read out by a computer, wherein
the information processing program executes
recognizing and setting as a selected section of a section facing a predetermined direction among a plurality of sections of a solid body, based on state information measured by a measurement section that is provided in the solid body and measures a state of the solid body with respect to three-dimensional space to obtain the state information; and
selecting and executing a function corresponding to the selected section among functions associated with a plurality of the sections in advance based on the recognized selected section.
